(19) United States
(12) Patent Application Publication
(10) Pub. No.: US 2026/0285176 A1
(43) Pub. Date: Sep. 24, 2026

(54) SYSTEM, MACHINE, CONTROL UNIT AND METHOD THEREIN FOR HANDLING A CABLE

(71) Applicant: EPIROC ROCK DRILLS AKTIEBOLAG, Örebro (SE)

(72) Inventor: Gustav MÖRTZELL, Örebro (SE)

(21) Appl. No.: 19/490,968

(22) PCT Filed: Jun. 8, 2023
(86) PCT No.: PCT/SE2023/050575

§ 371 Date: Dec. 8, 2025

(51) Int. Cl. B60L 53/18; B65H 75/42; B65H 75/44; H02G 11/02

(52) U.S. Cl. CPC B60L 53/18; B65H 75/425; B65H 75/4486; H02G 11/02

(57) ABSTRACT

The present invention relates to a cable handling system including an electrically powered mining or construction machine, the electrically powered mining or construction machine: including a cable reel including an electrical cable for providing electrical power to the electrically powered mining or construction machine when connected to a connection point of a remote source of electrical power, a winch including a winch cable, a connection point to a remote source of electrical power, a trundle located in proximity to the connection point, the winch cable unwound and applied from the winch through the trundle and back to the electrically powered mining or construction machine, is arranged to pull the electrical cable towards the connection point.

### TECHNICAL FIELD

Embodiment herein relates to a system, a machine, a method and arrangement for pulling an electrical cable towards a connection point of a remote source of electrical power.

### BACKGROUND OF THE INVENTION

Electrically powered mining and/or construction machines are increasing at mining and/or construction sites during the ongoing electrification to reduce emissions. Electrically powered mining and/or construction machines may e.g., comprise batteries for storing electrical energy or power. In order to recharge the batteries, the electrically powered mining and/or construction machines may comprise a cable stored on a cable reel. The electrical cable may be connected to a remote power source in order to provide power to the electrically powered mining and/or construction machines or to recharge the batteries thereon. Moving the electrical cable from the electrically powered mining and/or construction machine to a connection point to the remote power source may be a cumbersome operation.

Consequently, there is a need for improvements of the handling of the electrical cable.

### SUMMARY OF THE INVENTION

As part of developing embodiments herein a problem has been identified and will first be discussed.

When electrically powered mining and/or construction machines needs power, or to recharge its batteries, the batteries thereon may be changed at a battery changing station. This requires the electrically powered mining and/or construction machines to stop its current operations and move to the battery charging station. Alternatively, an electrical cable from the electrically powered mining and/or construction machines may be used to connect to a remote source of electrical power. However, connecting the electrical cable to the remote source of electrical power may be cumbersome, since the electrical cable may be heavy and the ground at the mining and/or construction site may be rough and/or uneven. Further, this task has to be performed manually. Thus, supplying the electrically powered mining and/or construction machines with electrical power may increase the risk of injuries to the operators of the machines, as well as reduce the operational efficiency at mining and/or construction sites.

An object of embodiments herein is to provide a mechanism that improves the cable handling in order to increase the operational efficiency and reduces the risk of injuries. The object is achieved by the independent claims.

According to a first aspect of the invention, the object is achieved by a cable handling system. The system comprises:
a connection point to a remote source of electrical power,
a trundle located in proximity to the connection point, and
an electrically powered mining or construction machine. The electrically powered mining or construction machine comprises:
a cable reel comprising an electrical cable for providing electrical power to the electrically powered mining or construction machine when connected to a connection point of a remote source of electrical power, and
a winch comprising a winch cable, wherein:
the winch cable, unwound and applied from the winch through the trundle and back to the electrically powered mining or construction machine, is arranged to pull the electrical cable towards the connection point. By provision of the system as disclosed herein, an improved cable handling system is provided, for which an electrical cable is pulled towards a connection point. In particular, it has been realized that by using a cable winch with a winch cable applied through a trundle located in proximity to a connection point to a remote power source, the which cable can pull the electrical cable to towards the connection point. Thereby, a simplified and automated cable handling system is achieved.

By a remote source of electrical power as used herein may be meant an electrical power grid, a battery station and/or a fuel cell station. A battery station may e.g., be an external battery to which one or more electrically powered mining or construction machine may connect. A fuel cell station may e.g., be a hydrogen powered fuel cell generating electrical power.

The winch may e.g., be powered by an electrical motor, e.g., the same electrical motor powering the electrically powered mining and/or construction machine. Alternatively, the winch may e.g., be powered by a hydraulic motor. The winch may comprise a winch reel upon which the winch cable is wound. Thus, a winch comprising a winch cable may e.g., mean a winch comprising a reel upon which the winch cable may be wound. Correspondingly, a cable reel comprising an electrical cable may e.g., mean a cable reel upon which the electrical cable may be wound.

According to an exemplary embodiment, a first end of the winch cable may be attached to a first end of the electrical cable. By attaching the first end of the winch cable to the first end of the electrical cable, the winch cable may be used to pull the electrical cable towards the connection point. The first end of the electrical cable may e.g., be the outer end, such as the end that is wound out from the cable reel. Correspondingly, the first end of the winch cable may e.g., be the outer end, such as the end that is wound out from the winch.

According to an exemplary embodiment, the first end of the electrical cable may comprise at least one of a cable connector and a cable grip. The first end of the winch cable may be attached to either of the cable connector or the cable grip. A cable connector may e.g., be a connector that may connected to the connection point of the remote electrical source. The cable connector may be a type of cable connector that corresponds to the connection point, meaning that it is possible to connect the cable connector to the connection point. A cable grip may e.g., be a device fastened to the electrical cable to be used for pulling the electrical cable. E.g., the winch cable may be attached, e.g., fastened, to the cable grip when pulling the electrical cable towards the connection point.

According to an exemplary embodiment, the electrical cable may be pulled towards the connection point by winding in the winch cable. In other words, the winch pulls the electrical cable towards the connection point by winding in the winch cable, where the winch cable e.g., is attached to the electrical cable.

According to an exemplary embodiment, the winch cable may be wound in until the first end of the electrical cable reaches the trundle.

According to an exemplary embodiment, the cable reel may be located in proximity to the winch.

According to a second aspect of the invention, the object is achieved by a method performed by a control unit for handling a cable. An electrically powered mining and/or construction machine comprises a cable reel comprising the cable. The electrically powered mining and/or construction machine further comprising a winch comprising a winch cable.

The control unit pulls the electrical cable towards a connection point to a remote source of electrical power. The electrical cable is pulled towards the connection point by the winch cable applied from the winch through a trundle, located in proximity to the connection point, and back to the electrically powered mining or construction machine.

According to a third aspect of the invention, the object is achieved by a control unit configured to handle a cable. An electrically powered mining and/or construction machine is adapted to comprise a cable reel adapted to comprise the cable. The electrically powered mining and/or construction machine is further adapted to comprise a winch adapted to comprise a winch cable The control unit further being configured to:
pull the electrical cable towards a connection point to a remote source of electrical power, wherein the electrical cable is adapted to be pulled towards the connection point by the winch cable adapted to be applied from the winch through a trundle, located in proximity to the connection point, and back to the electrically powered mining or construction machine.

According to a fourth aspect it is furthermore provided herein a computer program comprising instructions, which, when executed by a processing circuitry, causes the processing circuitry to perform method above, as performed by the control unit.

### BRIEF DESCRIPTION OF THE DRAWINGS

The present invention will hereinafter be further explained by means of non-limiting examples with reference to the appended schematic figures where;

FIG. 1 is a schematic view of a system according to an example embodiment herein;

FIGS. 2a-f are schematic views of attachment of a winch cable to an electrical cable according to example embodiments herein;

FIG. 3 is a schematic view of a system according to an example embodiment herein;

FIG. 4 is a flowchart depicting embodiments of a method in a control unit;

FIGS. 5a-b shows schematic block diagrams illustrating embodiments of a control unit.

It should be noted that the drawings have not necessarily been drawn to scale and that the dimensions of certain features may have been exaggerated for the sake of clarity. Like reference signs in the drawings refer to the same or similar element, unless expressed otherwise.

### DETAILED DESCRIPTION OF EMBODIMENTS

An object of embodiments herein is to provide a mechanism that improves the cable handling in order to increase the operational efficiency and reduces the risk of injuries. The object is achieved by the independent claims.

Embodiments herein may bring the advantage of an increased operational efficiency by an automated cable handling system. This may be achieved by, as mentioned above, making it possible to pull the electrical cable towards the connection point to the remote source of electrical power by using a winch cable that is applied through a trundle in proximity to the connection point, and then pull the electrical cable towards the connection point. Further, embodiments herein may bring the advantage of a reduced risk of injuries, since there is no need to manually pull the electrical cable from the electrically powered mining and/or construction machine to the connection point.

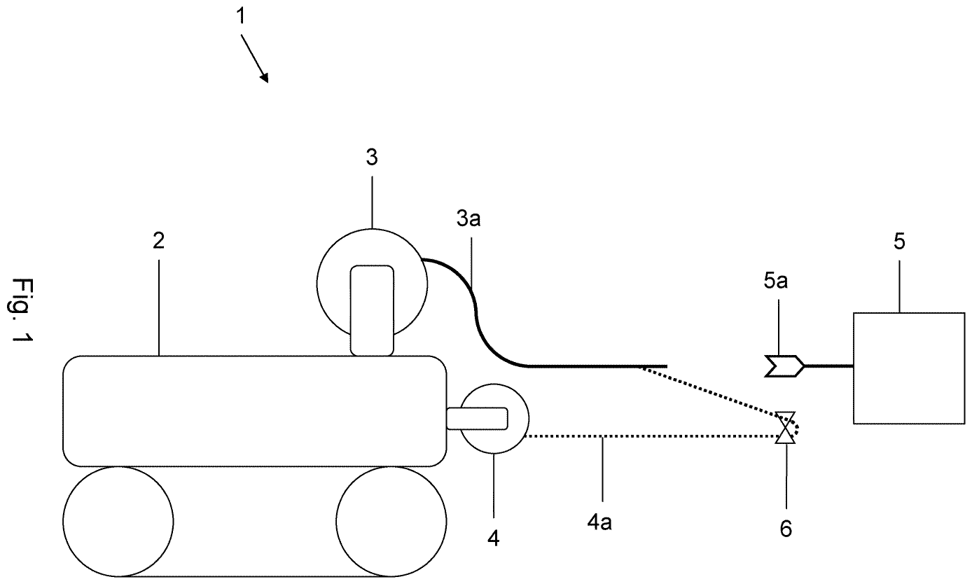

FIG. 1a depicts a schematic view a cable handling system 1 according to embodiments of the present invention. The cable handling system 1 comprises an electrically powered mining and/or construction machine 2. The electrically powered mining and/or construction machine 2 comprises a cable reel 3. The cable reel 3 comprises an electrical cable 3a for providing power to the electrically powered mining and/or construction machine 2 when connected to a connection point 5a of a remote source of electrical power 5. The electrically powered mining and/or construction machine 2 further comprises a winch 4, which winch comprises a winch cable 4a. The cable handling system 1 further comprises a trundle 6 that is located in proximity to the connection point 5a. The cable handling system 1 handles providing the electrical cable 3a from the electrically powered mining and/or construction machine 2 to the connection pint 5a e.g., by using the winch 4 and winch cable 4a to pull the electrical cable 3a towards the connection point 5a. The winch cable is unwound and pulled through the trundle 6 and back to the electrically powered mining and/or construction machine 2. The winch cable 4a then pulls the electrical cable 3a towards the connection point 5a.

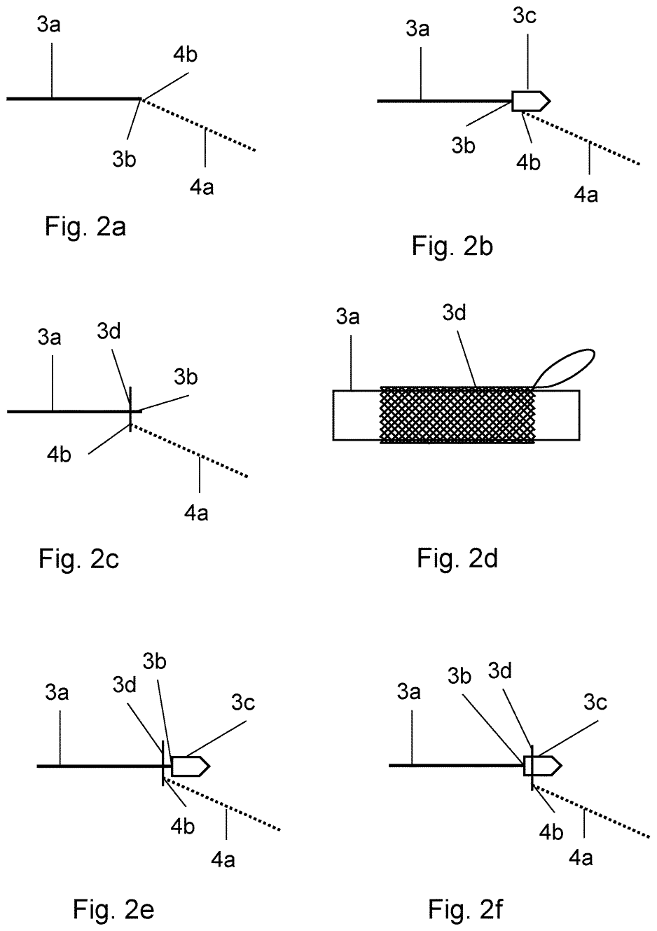

FIGS. 2a-e depicts schematic views of how the winch cable 4a may be attached to the electrical cable 3a. by attaching the winch cable 4a to the electrical cable 3a, the winch 4 and winch cable 4a may be used to pull the electrical cable 3a towards the connection point 5a.

FIG. 2a shows a first alternative attachment of the winch cable 4a to the electrical cable 3a. According to this first alternative, the electrical cable 3a comprises a first end 3b, and the winch cable 4a comprises a first end 4b. The first end 3b of the electrical cable 3a is attached to the first end 4b of the winch cable 4a.

FIG. 2b shows a second alternative attachment of the winch cable 4a to the electrical cable 3a. According to this second alternative, the electrical cable 3a comprises a cable connector 3c. The cable connector 3c may be attached, such as fastened, to the first end 3b of the electrical cable 3a. The winch cable 4a may be attached to the cable connected 3c. E.g., the first end 4b of the winch cable 4a may be attached to the cable connector 3c. The cable connector 3c may e.g., be a connector that may be connected to the connection point 5a of the remote source of electrical power 5. The cable connector 3c may be a type of cable connector that corresponds to the connection point 5a, meaning that it is possible to connect the cable connector 3c to the connection point 5a in order to provide electrical power to the electrically powered mining and/or construction machine 2.

FIG. 2c shows a third alternative attachment of the winch cable 4a to the electrical cable 3a. According to this third alternative, the electrical cable 3a comprises a cable grip 3d. The cable grip 3d may be attached, such as fastened, to the first end 3b of the electrical cable 3a. The winch cable 4a may be attached to the cable grip 3d. E.g., the first end 4b of the winch cable 4a may be attached to the cable grip 3d. The cable grip 3d may e.g., be a braided wire net arranged to form a hollow tubular shape, as shown in FIG. 2d. At one end of the hollow tubular shape, a loop or ring may be attached, arranged to allow e.g., the winch cable 4a to be connected or attached. The hollow tubular shape of the cable grip 3d, may be arranged around the electrical cable 3a, enabling the electrical cable 3a to be pulled by the winch cable 4a attached to the cable grip 3d. This is just one example of a how the cable grip 3d may be arranged, and should not be seen as limiting. Other types of cable grips may be used to achieve the same effect. It may be preferrable to attach the winch cable 4a to a cable grip 3d instead of the cable connector 3c. This since pulling the electrical cable 3a may incur stress and wear of the cable connector 3c, which may result in damage to the cable connector 3c.

FIG. 2e shows a fourth alternative attachment of the winch cable 4a to the electrical cable 3a. According to this fourth alternative, the electrical cable 3a comprises both the cable grip 3d and the cable connector 3c. the winch cable 4a may be attached to either of the cable grip 3d or the cable connector 3c. FIG. 2e shows an example where the winch cable 4a is attached to the cable grip 3d. The cable grip 3d may e.g., be arranged as described above. As mentioned above, It may be preferrable to attach the winch cable 4a to a cable grip 3d instead of the cable connector 3c. This since pulling the electrical cable 3a may incur stress and wear of the cable connector 3c, which may result in damage to the cable connector 3c.

FIG. 2f shows a fifth alternative attachment of the winch cable 4a to the electrical cable 3a. According to this fifth alternative, the electrical cable 3a comprises a combined cable connector 3c and cable grip 3d. In this example, the winch cable 4a may e.g., be attached the cable grip part of the combined cable connector 3c and cable grip 3d.

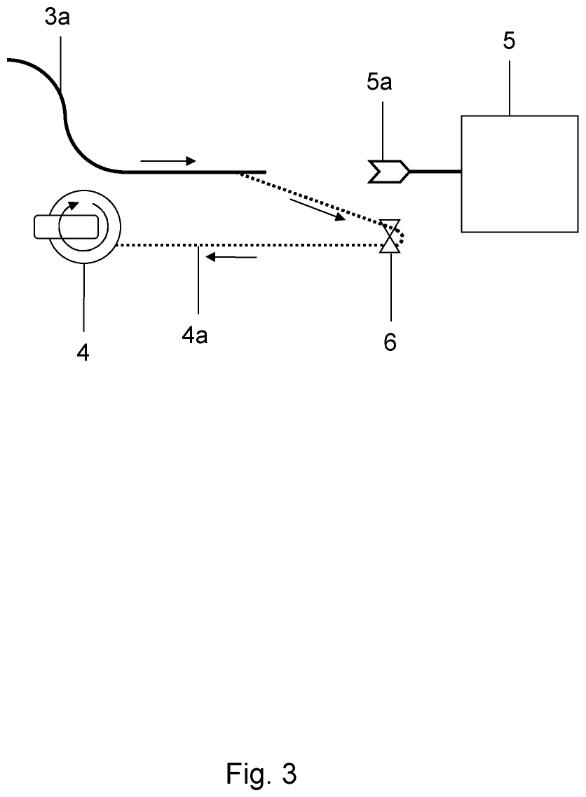

FIG. 3 depicts a simplified version of the of the cable handling system 1. According to some examples of embodiments herein, the electrical cable 3a may be pulled toward the connection point 5a by winding in the winch cable 4a, e.g., by using the winch 4. As shown in FIG. 3, the winch 4 winds in the winch cable 4a. Since the winch cable 4a is applied through the trundle 6, located in proximity to the connection point 5a, the electrical cable 3a is pulled towards the connection point 5a when the winch cable 4a is winded in. the electrical cable 3a may be pulled towards the connections point, e.g., by winding in the winch cable 4a, until the first end 3b, or the cable connector 3c attached to the first end 3b, of the cable 3a reaches the trundle 6.

In some examples of embodiments herein, one or more sensors may be used to determine when to stop pulling the cable 3a towards the connection point 5a. This may e.g., be when the first end 3b, or the cable connector 3c attached to the first end 3b, of the cable 3a reaches the trundle 6. The one or more sensors may e.g., be comprised, such as attached to, the first end 3b of the electrical cable 3a, the cable connector 3c, the cable grip 3d and/or the first end 4b of the winch cable 4a. Alternatively, the one or more sensors may be comprised in the electrically powered mining and/or construction machine 2. The one or more sensors may e.g., be a distance measurement sensor, a camera, a radar, a lidar, an object detection sensor, and/or any combination of these. The one or more sensor may e.g., provide a signal indicative a distance between the first end 3b, or the cable connector 3c attached to the first end 3b, of the cable 3a and the connection point 5a and/or the trundle 6. The signal indicative of the distance between the first end 3b, or the cable connector 3c attached to the first end 3b, of the cable 3a and the connection point 5a and/or the trundle 6 may e.g., be provided to a control unit 7 comprised in the electrically powered mining and/or construction machine 2 and/or a wireless device. The one or more sensors may e.g., be provide the signal to the control unit 7 by wireless and/or wired communication. In some examples, there may be combination of wired and wirelessly connected sensors connected to the control unit 7. Examples of the wireless connection may (but not limited to) be a Bluetooth connection, a WIFI connection, a cellular connection, such as a GSM, GPRS, EDGE, WCDMA, LTE and/or 5G cellular connection. The control unit 7 may determine a distance between the first end 3b, or the cable connector 3c attached to the first end 3b, of the cable 3a and the connection point 5a and/or the trundle 6 based on the received signal. By using the determined distance, the control unit 7 may further determine when the electrical cable 3a has reach the connection point 5a, such as the first end 3b, or the cable connector 3c attached to the first end 3b, of the cable 3a reaches the trundle 6. When determined that the electrical cable 3a has reached the connection point 5a, the control unit 7 may stop pulling the cable 3a towards the connection point 5a, e.g., by stopping the winding in the winch cable 4a. In some examples, the control unit 7 may further adapt the speed of pulling the electrical cable 3a towards the connection point 5a based in the distance between the first end 3b, or the cable connector 3c attached to the first end 3b, of the cable 3a and the connection point 5a and/or the trundle 6. E.g., the speed may be lowered when the distance is smaller than a first threshold.

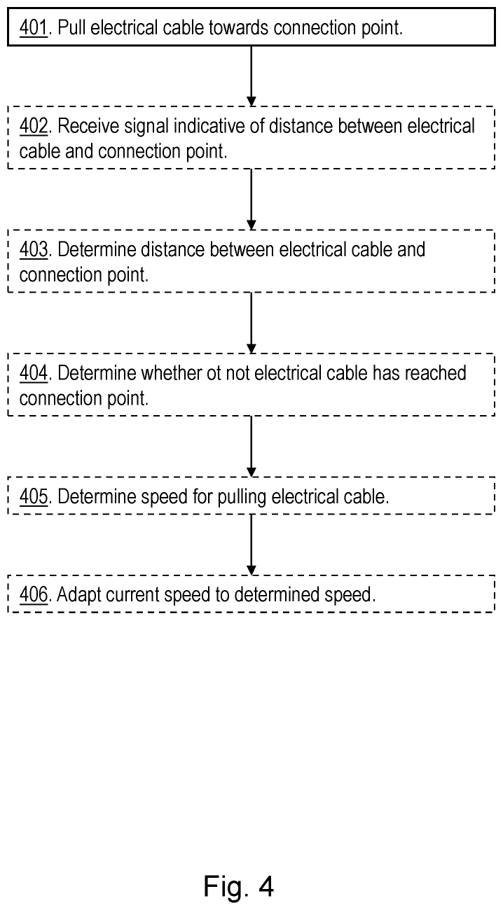

Thus, examples of embodiments herein may provide a method for handling the cable 3a, e.g., as shown in the flowchart in FIG. 4. The methods may be performed by the control unit 7 comprised in the electrically powered mining and/or construction machine 2. The control unit 7 may pull 401 the electrical cable 3a towards the connection point 5a, e.g., by winding in the winch cable 4a. The winch cable 4a may be unwound and applied from the winch 4 through the trundle 6 and back to the electrically powered mining or construction machine 2, and e.g., attached to the electrical cable 3a according to examples herein. Pulling the electrical cable 3a may further comprise to determine an initial speed for pulling the electrical cable 3a. The control unit 7 may receive 402 a signal indicative of a distance between the first end 3b, or the cable connector 3c attached to the first end 3b, of the cable 3a and the connection point 5a and/or the trundle 6. Based on the signal, the control unit 7 may determine 403 the distance between the first end 3b, or the cable connector 3c attached to the first end 3b, of the cable 3a and the connection point 5a and/or the trundle 6 and determine 404 whether or not the electrical cable 3a has reached the connection point, such as e.g., the first end 3b, or the cable connector 3c attached to the first end 3b, of the electrical cable 3a, has reached the trundle 6. When the electrical cable 3a has not reached the connection point 5a, the control unit 7 may determine 405 a speed for pulling the electrical cable 3a, e.g., based on the determined distance between the first end 3b, or the cable connector 3c attached to the first end 3b, of the cable 3a and the connection point 5a and/or the trundle 6, and adapt 406 the current speed to the determined speed. E.g., the control unit 7 may determine lower speed when the determined distance is lower than the first threshold. The control unit 7 may perform at least some of the steps 402-406 repeatedly while pulling the electrical cable 3a towards the connections point 5. Thus, the pulling speed may be adapted during the pulling of the electrical cable 3a, e.g., based on the distance between the first end 3b, or the cable connector 3c attached to the first end 3b, of the electrical cable 3a and the connection point 5a and/or the trundle 6.

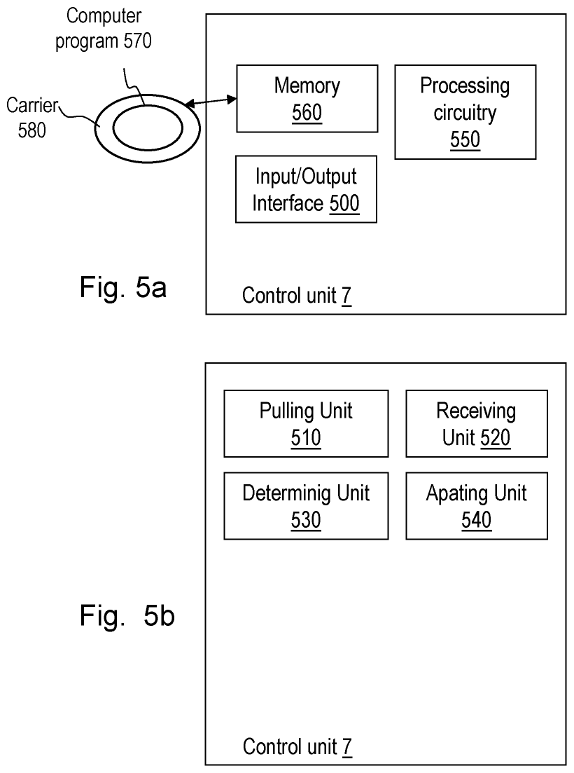

FIG. 5a disclose an example configuration of the control unit 7 configured to handle a cable 3a. The electrically powered mining and/or construction machine 1 is adapted to comprise the cable reel 3 adapted to comprise the cable 3a. The electrically powered mining and/or construction machine 2 is further adapted to comprise the winch 4 adapted to comprise the winch cable 4a. The control unit 7 comprises a memory 560 operable to store instructions and processing circuitry 550 operable to execute the instructions.

The control unit 7 may comprise an input and output interface 500 configured to communicate with, e.g., the winch 4 and the one or more sensors.

FIG. 5b also discloses an example configuration of processing circuitry for a central unit, e.g., the processing circuitry 550 disclosed in FIG. 5a. The processing circuitry may comprise a pulling unit 510, a receiving unit 520, a determining unit 530 and an adapting unit 540 configured to perform the methods above.

The embodiments herein may be implemented through the processing circuitry 550 in the control unit 7 depicted in FIG. 5a, together with respective computer program code for performing the functions and actions of the embodiments herein. The processing circuitry 550 may comprise one or more processors and one or more memory units. The memory units may be the memory 560. The program code mentioned above may also be provided as a computer program product, for instance in the form of a data carrier carrying computer program code for performing the embodiments herein when being loaded into the control unit 7. One such carrier may be in the form of a CD ROM disc, a USB flash drive, and/or an Over-the-Air (OTA) carrier. It is however feasible with other data carriers such as a memory stick. The computer program code may furthermore be provided as pure program code on a server and downloaded to the control unit 7.

The memory 560 of the control unit 7 may further comprise one or more memory units. The memory 560 is configured to store instructions executable by the processing circuitry 550. The memory 560 is arranged to be used to store e.g., information, messages, indications, configurations, pulling speeds, rotational speed, sensor data, characteristics, measurements, locations, positions, signals and applications to perform the methods herein when being executed in executed in the control unit 7.

The control unit 7 is configured to handle the cable 3. The control unit 7 pulls the electrical cable 3a towards the connection point 5a to the remote source of electrical power 5, wherein the electrical cable 3a is adapted to be pulled towards the connection point 5a by the winch cable 4a adapted to be applied from the winch 4 through the trundle (6), located in proximity to the connection point 5a, and back to the electrically powered mining or construction machine 2.

In some embodiments, a computer program 570 comprises instructions, which when executed by the processing circuitry 550, e.g., of the respective at least one processor of the processing circuitry 550, cause the processing circuitry 550 of the control unit 7 to perform the actions above.

In some embodiments, a respective carrier 580 comprises the respective computer program 570, wherein the carrier 580 is one of an electronic signal, an optical signal, an electromagnetic signal, a magnetic signal, an electric signal, a radio signal, a microwave signal, or a computer-readable storage medium.

Those skilled in the art will appreciate that the units in the control unit 7 described above may refer to a combination of analogue and digital circuits, and/or one or more processors configured with software and/or firmware, e.g., stored in the control unit 7, that when executed by the respective one or more processors such as the processors described above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC). It is to be understood that the present invention is not limited to the embodiments described above and illustrated in the drawings; rather, the skilled person will recognize that many changes and modifications may be made within the scope of the appended claims.

1. A cable handling system comprising:
an electrically powered mining or construction machine, the electrically powered mining or construction machine comprising:
a cable reel comprising an electrical cable for providing electrical power to the electrically powered mining or construction machine when connected to a connection point of a remote source of electrical power,
a winch comprising a winch cable,
a connection point to a remote source of electrical power,
a trundle located in proximity to the connection point, wherein:
the winch cable, unwound and applied from the winch through the trundle and back to the electrically powered mining or construction machine, is arranged to pull the electrical cable towards the connection point.

2. The system according to claim 1, wherein a first end of the winch cable is attached to a first end of the electrical cable.

3. The system according to claim 2, wherein the first end of the electrical cable comprises at least one of a cable connector and a cable grip, and wherein the first end of the winch cable is attached to either of the cable connector or the cable grip.

4. The system according to claim 1, wherein the electrical cable is pulled towards the connection point by winding in the winch cable.

5. The system according to claim 4, wherein the winch cable is wound in until the first end of the electrical cable reaches the trundle.

6. The system according to claim 1, wherein the cable reel is located in proximity to the winch.

7. A method performed by a control unit for handling a cable, wherein an electrically powered mining and/or construction machine comprises a cable reel comprising the cable, the electrically powered mining and/or construction machine further comprising a winch comprising a winch cable, the method comprising:
pulling the electrical cable towards a connection point to a remote source of electrical power, wherein the electrical cable is pulled towards the connection point by the winch cable applied from the winch through a trundle, located in proximity to the connection point, and back to the electrically powered mining or construction machine.

8. The method according to claim 7, wherein the method further comprises:
receiving a signal indicative of a distance between a first end, or a cable connector attached to the first end of the cable and the connection point and or the trundle, and
determining, based a distance between the first end or the cable connector attached to the first end of the cable and the connection point and/or the trundle, whether or not the electrical cable has reached the connection point.

9. A computer program comprising instructions, which when executed by a processing circuitry, causes the processing circuitry to perform actions according to claim 7.

10. A control unit configured to handle a cable wherein an electrically powered mining and/or construction machine is adapted to comprise a cable reel adapted to comprise the cable, the electrically powered mining and/or construction machine is further adapted to comprise a winch adapted to comprise a winch cable, the control unit further being configured to:
pull the electrical cable towards a connection point to a remote source of electrical power, wherein the electrical cable is adapted to be pulled towards the connection point by the winch cable adapted to be applied from the winch through a trundle, located in proximity to the connection point, and back to the electrically powered mining or construction machine.

11. The control unit according to claim 10, wherein the control unit is further configured to:
receive a signal indicative of a distance between a first end, or a cable connector attached to the first end, of the cable and the connection point and/or the trundle, and
determine, based a distance between the first end or the cable connector attached to the first end of the cable and the connection point and/or the trundle, whether or not the electrical cable has reached the connection point.

12. An electrically powered mining or construction machine comprising a cable reel comprising an electrical cable for providing electrical power to the electrically powered mining or construction machine when connected to a connection point of a remote source of electrical power, a winch comprising a winch cable, and a control unit according to claim 10.
